(19) United States
(12) Patent Application Publication
(10) Pub. No.: US 2024/0104569 A1
(43) Pub. Date: Mar. 28, 2024

(54) ENHANCED SECURITY MECHANISMS FOR BYPASS CHECKOUT SYSTEMS

(71) Applicant: Maplebear Inc. (dba Instacart), San Francisco, CA (US)

(72) Inventors: Rohit Turumella, San Jose, CA (US); Yehonatah Afek, San Francisco, CA (US); Chun-Che Wang, Seattle, WA (US); Leslie McFadden, San Jose, CA (US); Thomas Doan, Vancouver, WA (US)

(21) Appl. No.: 17/955,228

(22) Filed: Sep. 28, 2022

(51) Int. Cl. G06Q 20/40; G06Q 30/06

(52) U.S. Cl. CPC G06Q 20/4016; G06Q 30/0617; G06Q 30/0635

(57) ABSTRACT

An online concierge system facilitates a checkout bypass process for shoppers. The online concierge system detects when the shopper procuring an order for a customer is ready to exit the warehouse after obtaining the items in the order. The online concierge system applies a trained risk model to automatically determining whether to initiate an audit of the shopper. Responsive to determining to initiate the audit, the online concierge system invokes an auditing process. The online concierge system receives, via an auditor application, verification of the order from the auditor mobile application. Responsive to the verification, the online concierge system completes the order and generates routing instructions via the shopper mobile application for facilitating delivery by the shopper to the customer.

### BACKGROUND

This disclosure relates generally to an online concierge system for managing procurement and delivery of items to customers and more specifically to computer software and hardware for providing enhanced security mechanisms for bypass checkout systems.

In an online concierge system that facilitates procurement and delivery of items to customers from a physical warehouse, the checkout process can represent a significant bottleneck for shoppers. Enabling bypass of the checkout process can significantly improve efficiency and customer satisfaction, but can increase security risks if not carefully managed.

### SUMMARY

An online concierge system facilitates a checkout bypass process for shoppers in a manner that improves efficiency over a conventional checkout process while managing fraud risk. The online concierge system receives, via a customer mobile application, an order from a customer for one or more items from a warehouse. The online concierge system dispatches, via a shopper mobile application, a shopper to the warehouse for acquiring the one or more items in the order for the customer. The online concierge system detects when the shopper is ready to exit the warehouse after obtaining the items in the order. The online concierge system applies a trained risk model to automatically determining whether to initiate an audit of the shopper. Responsive to determining to initiate the audit, the online concierge system invokes an auditing process on the shopper mobile application and an auditor mobile application of an auditor at the warehouse to facilitate the auditing process. The online concierge system receives, via the auditor application, verification of the order from the auditor mobile application. Responsive to the verification, the online concierge system completes the order and generates routing instructions via the shopper mobile application for facilitating delivery by the shopper to the customer.

In various embodiments, the risk model may comprise a rule-based model or a machine learning model trained on historical data relating to the online concierge system.

In one or more embodiments, the risk model is based on at least one of a size of the order, a cost of the order, item types of the one or more items in the order, an experience level of the shopper, a trust metric for the shopper, an audit history of the shopper, a location of the warehouse, configured preferences of the warehouse, a current time, and a detected queue length of shoppers waiting to be audited.

In one or more embodiments, invoking the audit process comprises presenting a scannable code via a user interface of the shopper mobile application for scanning by the auditor via the auditor mobile application, identifying the order and the one or more items in the order based on the scannable code, and facilitating auditing of the order by the auditor via a user interface of the auditor mobile application.

In one or more embodiments, facilitating the auditing of the order may include presenting, via the auditor mobile application, identification of at least a subset of the one or more items in the order (e.g., in a ranked list), and presenting, via the auditor mobile application, user interface controls to enable the auditor to confirm presence of the subset of the one or more items or indicate presence of extraneous items outside of the order.

In one or more embodiments, presenting the user interface controls further may include presenting an interface for obtaining a reason for the discrepancy according to the auditor in response to receiving an indication via the user interface controls of a discrepancy in items presented by the shopper and the order, and storing an indication of the discrepancy and the reason in an audit log associated with the order and the shopper.

In one or more embodiments, presenting the user interface controls further may include determining the subset of the one or more items for verifying by the auditor based on a machine learning model trained based on historical audit data to identify items most likely to be involved in a discrepancy discovered by the auditing process.

In one or more embodiments, presenting the user interface controls may include presenting controls for scanning product codes associated with individual items presented by the shopper, and matching the product codes to the one or more items in the order to verify presence of the subset of the one or more items or indicate the presence of extraneous items outside the order.

One or more embodiments may further include a computer program product including a non-transitory computer-readable storage medium storing instructions for execution by a processor to carry out the methods described herein.

Another embodiment may include a computer system including a processor and a non-transitory computer-readable storage medium storing instructions for execution by the processor for carrying out the methods described herein.

### BRIEF DESCRIPTION OF THE DRAWINGS

FIG. 1 is a block diagram of a system environment in which an online system, such an online concierge system, operates, according to one or more embodiments.

FIG. 2 illustrates an environment of an online shopping concierge service, according to one or more embodiments.

FIG. 3 is a diagram of an online shopping concierge system, according to one or more embodiments.

FIG. 4 is a block diagram of a checkout bypass engine, according to one or more embodiments.

FIG. 5A is a diagram of a customer mobile application, according to one or more embodiments.

FIG. 5B is a diagram of a shopper mobile application, according to one or more embodiments.

FIG. 5C is a diagram of an auditor mobile application, according to one or more embodiments.

FIG. 6 is a sequence of user interface screens associated with an shopper mobile application during a checkout bypass process, according to one or more embodiments.

FIG. 7 is a sequence of user interface screens associated with an auditor mobile application during a checkout bypass process, according to one or more embodiments.

FIG. 8 is a flowchart illustrating an example embodiment of a process for facilitating a checkout bypass process in an online concierge system.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Architecture

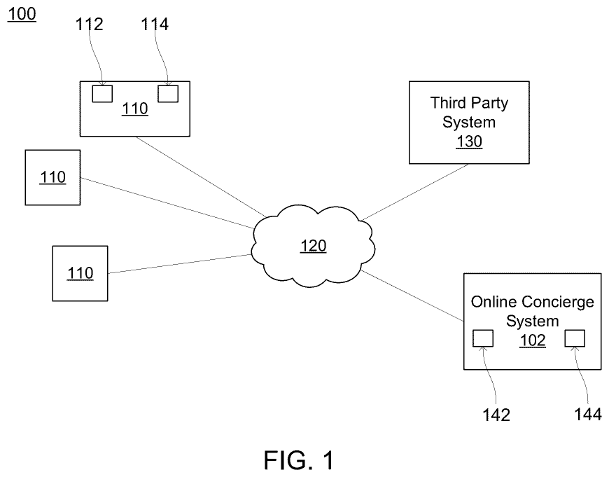

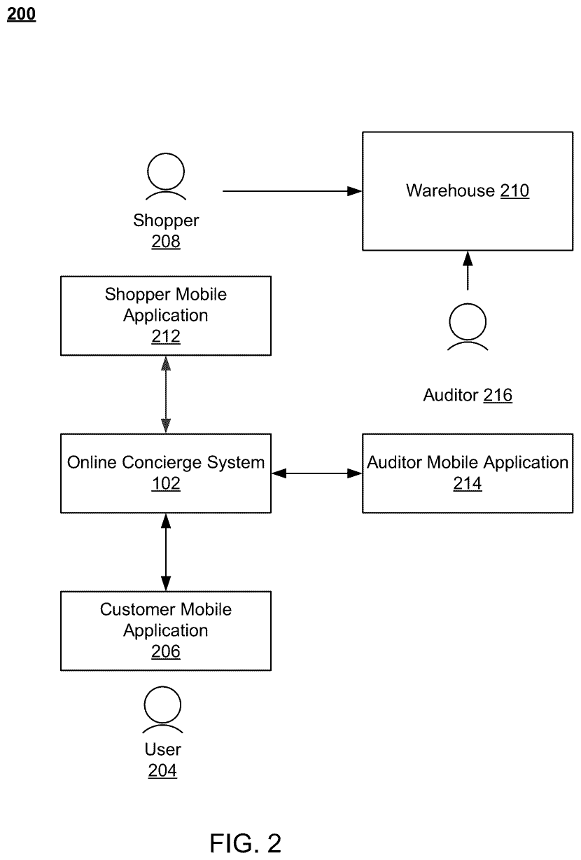

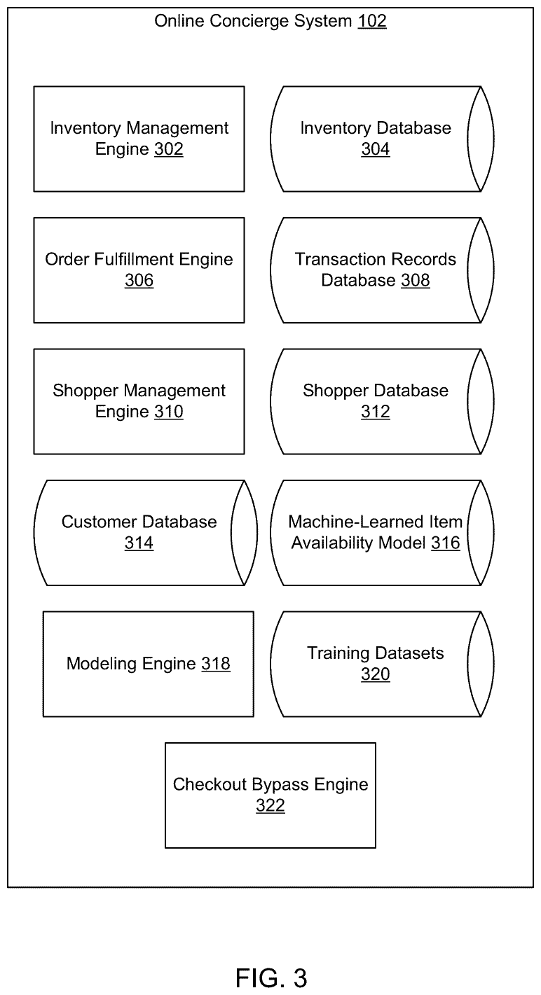

FIG. 1 is a block diagram of a system environment 100 in which an online system operates, such as an online concierge system 102 as further described below in conjunction with FIGS. 2 and 3. The system environment 100 shown in FIG. 1 comprises one or more client devices 110, a network 120, one or more third party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

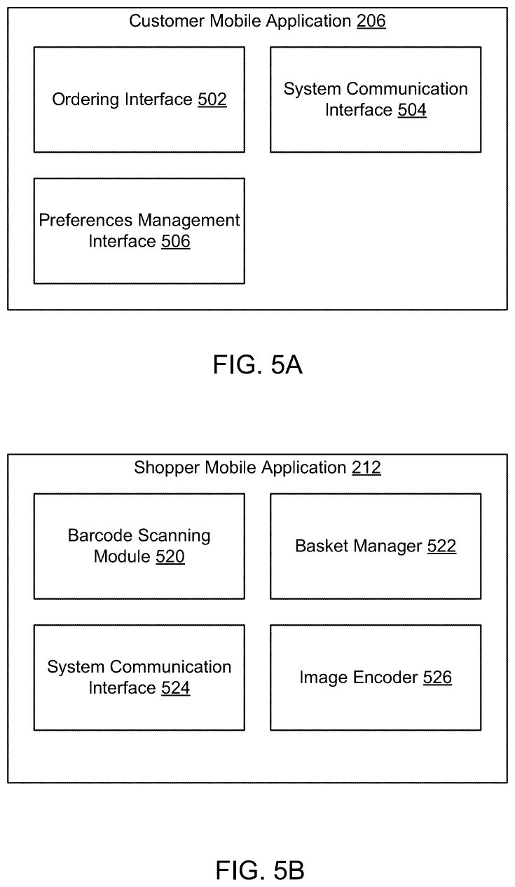

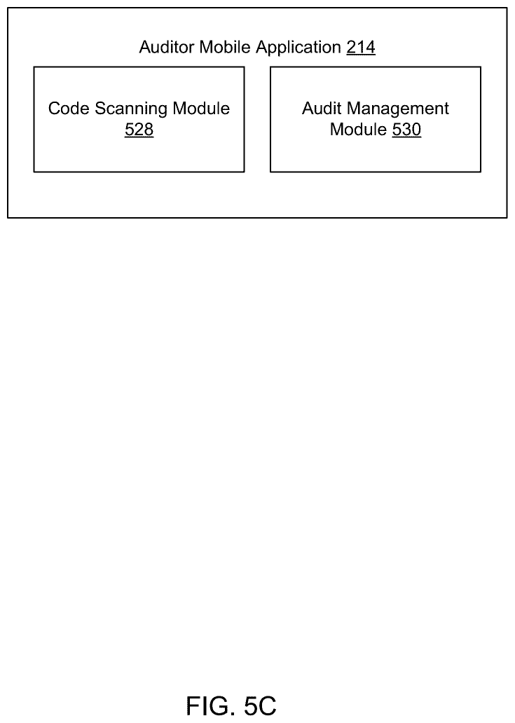

The client devices 110 are one or more computing devices capable of receiving user input as well as transmitting and/or receiving data via the network 120. In one or more embodiments, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one or more embodiments, a client device 110 executes an application allowing a user of the client device 110 to interact with the online concierge system 102. For example, the client device 110 executes a customer mobile application 206, a shopper mobile application 212, or an auditor mobile application 214 as further described below in conjunction with FIGS. 5A-C, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206, the shopper mobile application 212, or the auditor mobile application 214 to provide the functions further described herein in conjunction with FIGS. 5A-C, respectively.

The client devices 110 are configured to communicate via the network 120, which may comprise any combination of local area and/or wide area networks, using both wired and/or wireless communication systems. In one or more embodiments, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online concierge system 102 or with the one or more client devices 110. In one or more embodiments, a third party system 130 is an application provider communicating information describing applications for execution by a client device 110 or communicating data to client devices 110 for use by an application executing on the client device. In other embodiments, a third party system 130 provides content or other information for presentation via a client device 110. For example, the third party system 130 stores one or more web pages and transmits the web pages to a client device 110 or to the online concierge system 102. The third party system 130 may also communicate information to the online concierge system 102, such as advertisements, content, or information about an application provided by the third party system 130.

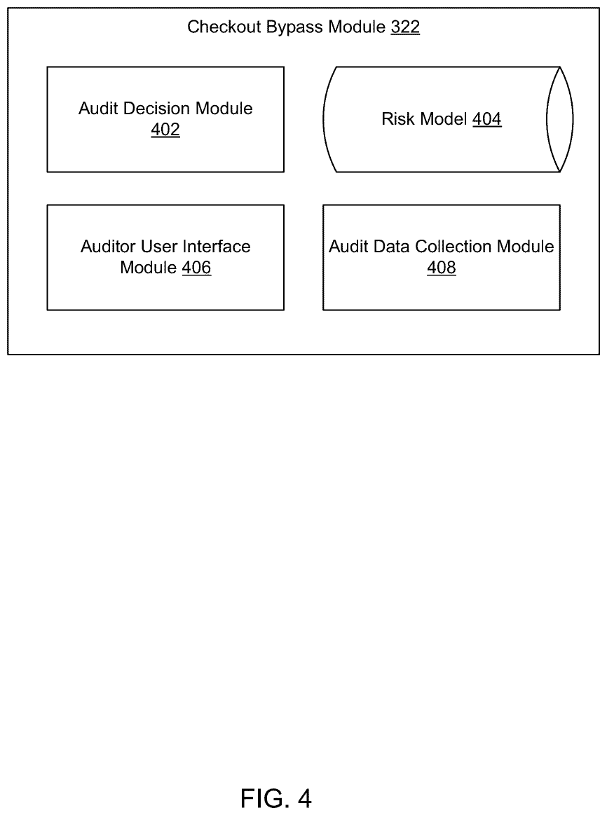

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIGS. 3-4 that, when executed by the processor 142, cause the processor to perform the functionality further described herein in relation to FIGS. 2-8. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device, a third party system 130, or the online concierge system 102 may be special purpose computing devices configured to perform specific functions, as further described below in conjunction with FIGS. 2-8, and may include specific computing components such as processors, memories, communication interfaces, and/or the like.

### System Overview

FIG. 2 illustrates an environment 200 of an online platform, such as an online concierge system 102, according to one or more embodiments. The figures use like reference numerals to identify like elements.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered (e.g., based around an order fulfillment time). In some embodiments, the order specifies one or more warehouses 210 from which the selected items should be purchased. The user may use a customer mobile application 206 to place the order; the customer mobile application 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 may include multiple warehouses 210 (only one is shown for the sake of simplicity; the environment 200 could include hundreds of warehouses 210). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one or more embodiments, shoppers 208 make use of a shopper mobile application 212 which is configured to interact with the online concierge system 102.

Some warehouses 210 may offer a checkout bypass to shoppers 208 fulfilling orders for the online concierge system 102. In this case, the shopper 208 need not go to the general checkout area of the warehouse 210 and may instead proceed to a checkout bypass area of the warehouse 210 designed to provide a more efficient purchase process. In some instances, the shopper 208 may be allowed to leave the store without individually scanning the items into a standard checkout system. In this case, the online concierge system 102 may automatically facilitate a purchase process with the warehouse 210 associated with the items in the order without necessarily verifying that the shopper 208 has the right items. For example, the items in the order may be automatically entered into a point-of-sale system for the warehouse 210 as if the items had been individually scanned. In other instances, an efficient checkout interaction may be facilitated prior to the shopper 208 exiting the warehouse 210 with the procured items. For example, the shopper mobile application 212 may present a scannable code identifying the order that can be scanned prior to the shopper 208 exiting the warehouse 210. Scanning the code signals to the warehouse 210 and the online concierge system 102 that the items in the order have been acquired and enables the shopper 208 to proceed with delivery of the items to the user 204.

In some cases, an audit process may be invoked in which the shopper 208 interacts with a human or automated auditor 216 that facilitates an audit of the order. The audit process may be designed to reduce the likelihood of fraud while still providing a more efficient exit process for the shopper 208 than a traditional checkout. In the case of a human auditor 216, the audit process may be facilitated by an auditor mobile application 214 in communication with the online concierge system 102. Here, the auditor mobile application 214 may facilitate a verification of all or a subset of the items bagged by the shopper 208 and may flag any discrepancies (e.g., items missing from the order or items that were not part of the order). The auditor mobile application 214 may provide notifications of any discrepancies and such discrepancies may furthermore be stored to an audit log. In some embodiments, the online concierge system 102 may enable the shopper to proceed to delivery (e.g., by providing the routing instructions via the shopper mobile application 212) only upon completing the verification process. Furthermore, the auditing process may report any discrepancies to the online concierge system 102 and/or the warehouse 210. In another embodiment, the audit may be conducted automatically without necessarily requiring a human auditor. For example, the audit may be facilitated by a kiosk or robotic auditing system.

In various embodiments, the auditing process may intelligently determine whether to audit an individual shopper 208 and intelligently determine the scope of the audit (e.g., how many items to verify, specific items to verify, etc.) In this case, different shoppers 208 may experience different levels of audits (or none at all) dependent on various factors designed to manage the tradeoff between providing an efficient checkout process and reducing fraud. Examples of an auditing process are described in further detail below.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one or more embodiments, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, SKU, serial number, and so on. In one or more embodiments, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210. Different levels in the taxonomy may provide different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which items are available at which warehouse 210. The order fulfillment engine 306 may supplement the item availability information from the inventory database 234 with an item availability predicted by the machine-learned item availability model 316. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one or more embodiments, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device of a user for display via the customer mobile application 106. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one or more embodiments, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one or more embodiments, the shopper management engine 310 receives a new order from the order fulfillment engine 306. The shopper management engine 310 identifies the appropriate warehouse 210 to fulfill the order based on one or more parameters, such as a probability of item availability determined by a machine-learned item availability model 316, the contents of the order, the inventory of the warehouses, restocking information, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a user database 314 which stores information describing each user. This information could include each user's name, address, gender, shopping preferences, favorite items, stored payment instruments, and so on.

In various embodiments, the order fulfillment engine 306 determines whether to delay display of a received order to shoppers for fulfillment by a time interval. In response to determining to delay the received order by a time interval, the order fulfillment engine 306 evaluates orders received after the received order and during the time interval for inclusion in one or more batches that also include the received order. After the time interval, the order fulfillment engine 306 displays the order to one or more shoppers via the shopper mobile application 212; if the order fulfillment engine 306 generated one or more batches including the received order and one or more orders received after the received order and during the time interval, the one or more batches are also displayed to one or more shoppers via the shopper mobile application 212.

### Machine Learning Models

The online concierge system 102 further includes a machine-learned item availability model 316, a modeling engine 318, and training datasets 320. The modeling engine 318 uses the training datasets 320 to generate the machine-learned item availability model 316. The machine-learned item availability model 316 can learn from the training datasets 320, rather than follow only explicitly programmed instructions. The inventory management engine 302, order fulfillment engine 306, and/or shopper management engine 310 can use the machine-learned item availability model 316 to determine a probability that an item is available at a warehouse 210. The machine-learned item availability model 316 may be used to predict item availability for items being displayed to or selected by a user or included in received delivery orders. A single machine-learned item availability model 316 is used to predict the availability of any number of items.

The machine-learned item availability model 316 can be configured to receive as inputs information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the item availability model 316.

The machine-learned item availability model 316 contains a set of functions generated by the modeling engine 318 from the training datasets 320 that relate the item, warehouse, and timing information, and/or any other relevant inputs, to the probability that the item is available at a warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the item availability model 316 may be updated and adapted following retraining with new training datasets 320. The machine-learned item availability model 316 may be any machine learning model, such as a neural network, boosted tree, gradient boosted tree, or random forest model. In some examples, the machine-learned item availability model 316 is generated from XGBoost algorithm. The item probability generated by the machine-learned item availability model 316 may be used to determine instructions delivered to the user 204 and/or shopper 208.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 304). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previous delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be the bakery, beverage, nonfood, and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include an item type associated with the item. For example, if the item is a particular brand of an item, then the item type will be a generic description of the item type, such as “milk” or “eggs.” The item type may affect the item availability, since certain item types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether the item is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

### Checkout Bypass Engine

The checkout bypass engine 322 facilitates various checkout bypass processes for shoppers 208 associated with the online concierge system 102. The checkout bypass engine 322 may be designed to enable a more efficient order completion process than a standard retail checkout process while still including various checks to mitigate the possibility of fraud. For example, the checkout bypass engine 322 may invoke an audit process for some or all shoppers 208. One or more embodiments of a checkout bypass engine 322 is described in further detail with respect to FIG. 4 below.

FIG. 4 is a block diagram illustrating an example embodiment of a checkout bypass engine 322. The checkout bypass engine 322 includes an audit decision module 402, a risk model 404, an auditor user interface module 406, and an audit data collection module 408. In alternative embodiments, the checkout bypass engine 322 includes additional or different modules.

The audit decision module 402 determines, based on the risk model 404, whether to initiate an audit process for a shopper 208 prior to the shopper 208 exiting the warehouse 210 with items for an order. If the audit decision module 402 determines not to initiate an audit, the shopper 208 may be permitted to proceed with delivery of the order without a traditional checkout process. For example, the audit decision module 402 may send a signal to the order fulfillment engine 306 indicating that the items in the order have been obtained by the shopper 208 and may cause a point-of-sale system of the warehouse 210 to initiate sales of the items as if the items had been individually scanned. The audit decision module 402 may furthermore cause the shopper mobile application 212 to update its user interface to proceed to facilitating delivery of the items to the customer, e.g., by providing navigation instructions for routing the shopper to the customer.

In one or more embodiments, the audit decision module 402 may detect when the shopper 208 has acquired the items in the order and make the audit decision responsive to an input received from the shopper 208 in the shopper mobile application 212 indicating that the items have been obtained. For example, the shopper 208 may select a control element in the shopper mobile application 212 to mark the order as ready for checkout. In another embodiment, the shopper mobile application 212 may allow the shopper to check off individual items in the order as they are obtained, and may trigger the audit decision module 402 to provide the audit decision when all items in the order have been checked off. In yet another embodiment, the audit decision module 402 may detect when the shopper 208 is present in a checkout bypass area of the warehouse 210 and provide the audit decision in response to detection. For example, the audit decision module 402 may detect the shopper's location 208 based on the shopper 208 scanning a code (e.g., a QR code or barcode) using the shopper mobile application 212 that is positioned in the checkout bypass area of the warehouse 210. In another embodiment, a different location detection mechanism may be employed to detect the shopper's location.

In one or more embodiments, the audit decision module 402 may make the decision of whether the audit the shopper 208 based on a risk model 404 incorporating various factors including, for example, a size of the order, a cost of the order, item types of the one or more items in the order (whether the order contains alcohol, prescriptions, or other specific item types), an experience level of the shopper 208, a trust metric for the shopper 208, an audit history of the shopper 208, a location of the warehouse, configured preferences of the warehouse, a current time, and a detected queue length of shopper waiting to be audited. For example, shoppers 208 with a long history of shopping for the online concierge system 102 without prior incidents of suspected fraud (e.g., a high trust metric) may be more likely to proceed to delivery without audit, or may have only a limited audit conducted. Furthermore, if a significant number of shoppers 208 are waiting to exit the warehouse 210, the audit decision module 402 may be more likely to skip an audit (or conduct a more limited audit) than during less busy times. Shoppers obtaining items more likely to be associated with fraud, such as alcohol or prescriptions, may furthermore be more likely to be audited. Individuals warehouses 210 may furthermore be able to set individual configuration parameters that may influence how often shoppers 208 are audited and the extent of the audits.

In some embodiments, the audit decision module 402 may determine a scope of an audit. For example, in some audits, the auditor may be instructed to scan a predefined number of randomly selected items to verify that the items each match items in the order. The number of items for scanning may vary under different audit scopes. Furthermore, in some audits, the auditor may be instructed to verify and scan one or more specific items in the order. In this case, the audit decision module 402 may suggest (or require) which items to verify based on various factors such as, for example, respective costs of the one or more items in the order, respective quantities of the one or more items in the order, a type of item (e.g., items with alcohol), historical data indicative of items most likely to be involved in a discrepancy discovered by the auditing process, and configuration data provided by the warehouse 210. In other embodiments, the items selected for verification may be randomly selected. In further types of audits, the audit may include verifying both a subset of items selected by the auditor 216 and a specific set of items selected by the audit decision module 402. Other audits may be left to the discretion of the auditor, with the audit decision module 402 optionally providing suggestions based on the risk model 404 that the auditor can choose whether to follow.

The risk model 404 may model the risk (e.g., fraud or mistake) and/or benefits (e.g., checkout efficiency) associated with conducting different scopes of audit in order to determine the audit decision. In one or more embodiments, the risk model 404 may comprise a rule-based model comprising a set of rules for making an audit decision based on the various factors described herein. The rules may be customizable to different warehouses 210. The risk model 404 may include separate sets of rules for determining whether to conduct an audit and for determining the scope of the audit.

In another embodiment, the risk model 404 comprises a machine learning model trained on historical data to infer an optimal audit decision. For example, in one or more embodiments, a machine learning algorithm may be trained to map input feature vectors (which may represent the various input factors described above) to an output metric observed in the historical data. The output metric may be derived from observed data such as occurrences of discovered order discrepancies, customer complaints, checkout and/or delivery time, or other criteria (or combination thereof). The risk model 404 may be periodically retrained as new audit data is collected to improve its prediction power. In one or more embodiments, the risk model may include separately trained models for determining whether to conduct an audit and for determining the scope of the audit (e.g., which items to verify or how many items to verify).

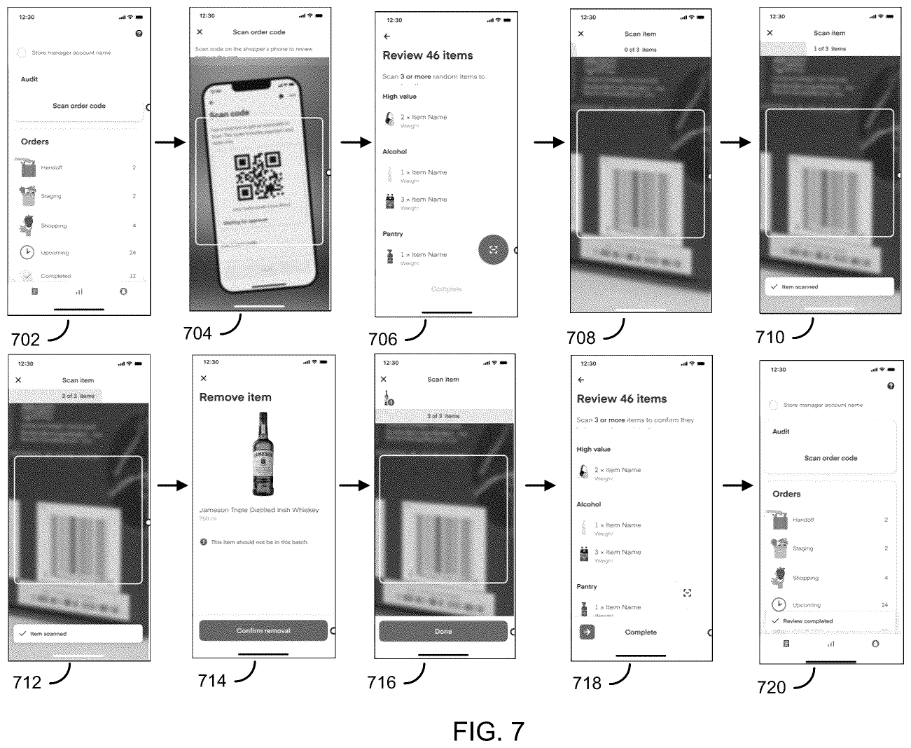

The auditor user interface module 406 facilitates operation of an auditor user interface accessed via the auditor mobile application 214. This user interface may guide the auditor 216 through the auditing process and provide controls to enable the auditor 216 to input results of the audit. For example, the user interface may instruct the auditor 216 regarding the suggested scope of the audit (e.g., how many items to scan, whether to scan specific items or randomly chosen items, etc.). The user interface may furthermore provide a scanning tool to enable the auditor 216 to scan items and indicate which items are present. If a discrepancy is observed, the auditor user interface module 406 may enable the auditor to enter feedback indicating whether the discrepancy appears to be fraud, mistake, or unknown. An example embodiment of an auditor user interface is described in further detail below with respect to FIG. 7.

The audit data collection module 408 collects data relating to an audit and stores the data to an audit log. The audit logs may be used to retrain machine learning models (e.g., the risk model 404) and/or generate analytical data for an administrator of the online concierge system 102 or individual warehouses 210. The audit data may include, for example, information enumerating items that were audited and whether they were verified, identification of items that resulted in discrepancies, identification of the shopper 208, identification of the warehouse 210, information about the order being audited, a time of the audit, a duration of the audit, or other information relevant to evaluating the audit process.

### Customer Mobile Application

FIG. 5A is a diagram of the customer mobile application 206, according to one or more embodiments. The customer mobile application 206 includes an ordering interface 502, which provides an interactive interface with which the user 104 can browse through and select items and place an order. The customer mobile application 206 also includes a system communication interface 504 which, among other functions, receives inventory information from the online concierge system 102 and transmits order information to the online concierge system 102. The customer mobile application 206 also includes a preferences management interface 506 which allows the user 104 to manage basic information associated with his/her account, such as his/her home address and payment instruments. The preferences management interface 506 may also allow the user to manage other details such as his/her favorite or preferred warehouses 210, preferred delivery times, special instructions for delivery, and so on.

### Shopper Mobile Application

FIG. 5B is a diagram of the shopper mobile application 212, according to one or more embodiments. The shopper mobile application 212 includes a barcode scanning module 520 which allows a shopper 208 to scan an item at a warehouse 210 (such as a can of soup on the shelf at a grocery store). The barcode scanning module 520 may also include an interface which allows the shopper 108 to manually enter information describing an item (such as its serial number, SKU, quantity and/or weight) if a barcode is not available to be scanned. shopper mobile application 212 also includes a basket manager 522 which maintains a running record of items collected by the shopper 208 for purchase at a warehouse 210. This running record of items is commonly known as a “basket.” In one or more embodiments, the barcode scanning module 520 transmits information describing each item (such as its cost, quantity, weight, etc.) to the basket manager 522, which updates its basket accordingly. The shopper mobile application 212 also includes a system communication interface 524 which interacts with the online concierge system 102. For example, the system communication interface 524 receives an order from the online concierge system 102 and transmits the contents of a basket of items to the online concierge system 102. The shopper mobile application 212 also includes an image encoder 526 which encodes the contents of a basket into an image. For example, the image encoder 526 may encode a basket of goods (with an identification of each item) into a QR code which can then be scanned by an employee of the warehouse 210 at check-out.

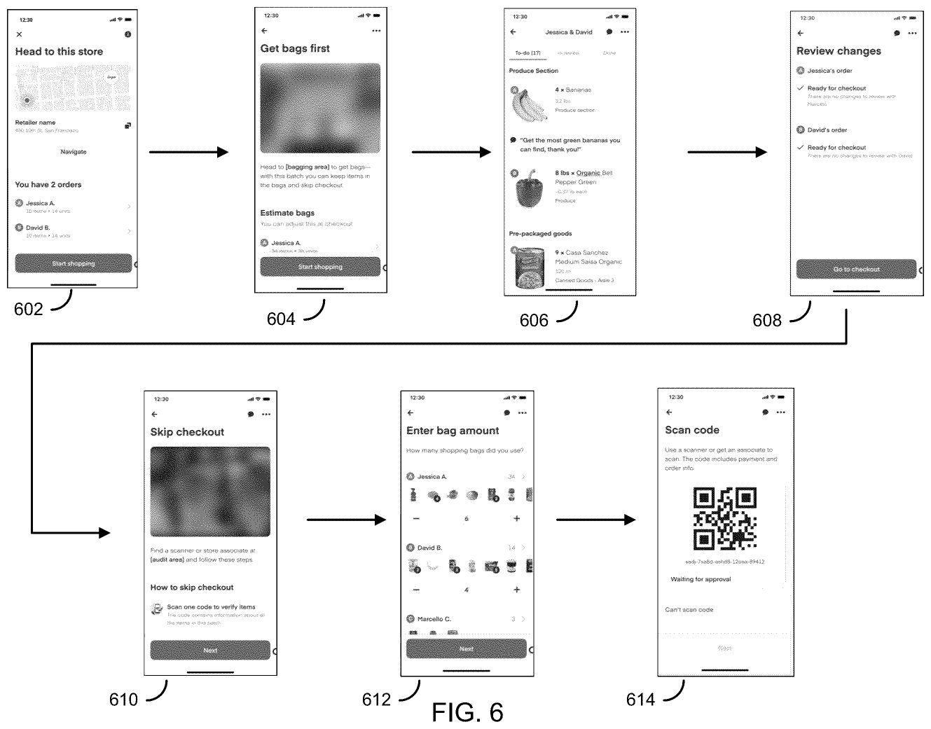

The shopper mobile application 212 may include an interface for facilitating a checkout bypass process as further described below. Here, the shopper mobile application 212 may direct the shopper to a checkout bypass area of the warehouse 210 and may provide instructions for interacting with an auditor 216 to determine whether an audit will be conducted and if so, to facilitate processing of the audit. An example interface associated with the checkout bypass process of an shopper mobile application 212 is described in further detail below with respect to FIG. 6.

### Auditor Mobile Application

FIG. 5C is a diagram of the auditor mobile application 214, according to one or more embodiments. The auditor mobile application 214 includes a code scanning module 528 and an audit management module 530. The code scanning module 528 includes an interface and scanning logic for enabling an auditor 216 to electronically obtain a scannable code associated with an item (such as its serial number, SKU, quantity and/or weight). In one or more embodiments, the code scanning module 528 may be implemented using a camera interface of a mobile device and an image processing application that interprets the scannable code. The code scanning module 528 may furthermore include an interface for manually entering a code or other identifying information for an item in the event that the scannable code is not present or cannot otherwise be successfully scanned.

The audit management module 530 includes interfaces for facilitating an audit process. For example, the audit management module 530 may communicate with the checkout bypass engine 322 to obtain an audit decision for a shopper 208, to provide instructions to the auditor for facilitating the audit, and to enable the auditor to enter results of the audit. User interfaces associated with the audit management module 530 are described in further detail below with respect to FIG. 7.

### User Interfaces

FIG. 6 is an example sequence of user interfaces associated with the shopper mobile application 212 relating to the checkout bypass. Screen 602 illustrates an interface alerting the shopper 208 that there is one or more order assigned to the shopper 208. This interface may provide navigation directions to the warehouse 210 from the shopper's location. At screen 604, the interface instructs the shopper 208 to obtain bags for the order. At screen 606 the interface lists individual items (and customer comments) in the one or more active orders. The screen 606 may indicate the type of item, the requested quantity, the location of the item, or other information relevant to the shopper 208 locating the item in the warehouse 210. The shopper 208 may check off each item as they are obtained to track status of the order. At screen 608, the interface indicates that the order is ready for checkout. At screen 610, the shopper 208 is presented with an option to bypass checkout. This screen 610 may furthermore provide instructions for facilitating checkout bypass. At screen 612, the customer enters the number of shopping bags used for each order. At screen 614, a scannable code is presented that can be scanned by the auditor 216. The scan may initiate the auditing process described herein.

In alternative embodiments, different or additional user interfaces may be presented. For example, in one or more embodiments, the shopper 208 may be directed to obtain bags at the end (once items are procured) instead of at the beginning.

FIG. 7 is an example sequence of user interface screens of the auditor mobile application 214 relating to the checkout bypass process. Screen 702 is an order status interface providing information about ongoing and upcoming shopper activity at the warehouse 210. In this example, the screen 702 includes order information organized by status (e.g., handoff to customer, staging, shopping, upcoming, completed, etc.). Screen 704 is a camera interface with a view of the scannable code on the shopper mobile application 212 (e.g., screen 614 in the example of FIG. 6 above). The auditor mobile application 214 captures the scannable code to identify the order. Screen 706 provides an order summary of an example order associated with the scannable code. In this example, the screen 706 instructs the auditor to scan three or more random items from the shopper's cart to facilitate the audit process. The screen 706 shows the items in categories (which could be ranked) to suggest items that are more likely to be associated with fraud (e.g., high value items, alcohol, etc.). In screen 708, 710, 712, 716, the auditor mobile application 214 provides a camera interface that enables scanning of bar codes associated with specific items. As each item is scanned, the auditor mobile application 214 may confirm that the scanned item matches an item in the order. Screen 714 shows an example interface when a scanned item is not part of the order. The screen 714 indicates that the item should not be in the order and provides instructions for the auditor 216 to confirm removal of the item. Screen 718 shows the order summary with a user control that enables the auditor 216 to select to complete the audit. In an example embodiment, this control element may become available after the auditor scans the minimum number of items (e.g., 3 items in this example). Screen 720 returns to the order status interface upon the auditor indicating that the audit is complete.

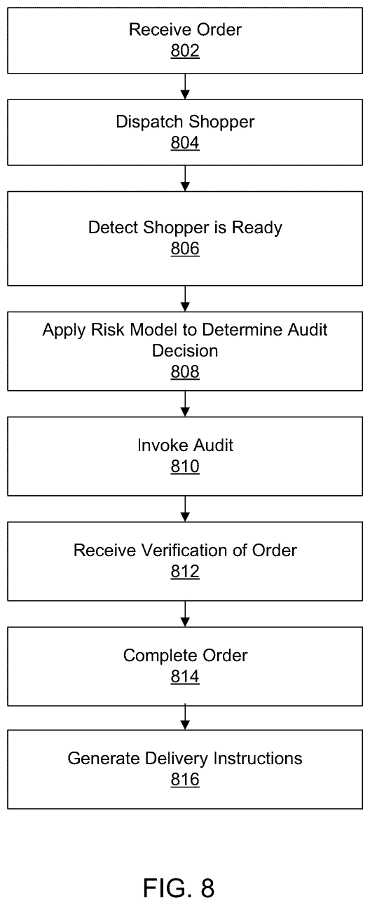

FIG. 8 is a flowchart illustrating an example embodiment of a process for facilitating a checkout bypass in an online concierge system 102. The online concierge system 102 receives 802, via a customer mobile application 206, an order from a user 204 for one or more items from a warehouse 210. The online concierge system 102 dispatches 804 (e.g., via the shopper mobile application 212) a shopper 208 to the warehouse 210 for acquiring the one or more items in the order for the user 204. After the shopper 208 obtains the items in the order, the online concierge system 102 detects 806 that the shopper 208 is ready to exit the warehouse 210. For example, the shopper mobile application 212 may detect when the shopper 208 has obtained all of the items in the order or otherwise marked the order as complete. Alternatively, the shopper mobile application 212 may detect when the shopper 208 is in a checkout bypass area of the store using various location detection mechanisms. The online concierge system 102 applies 808 a trained risk model to automatically determine whether to initiate an audit of the shopper 208. The model may be a rule-based model or a machine learning model. The risk model may be based on various factors such as, for example, a size of the order, a cost of the order, item types of the one or more items in the order, an experience level of the shopper, a trust metric for the shopper, an audit history of the shopper, a location of the warehouse, configured preferences of the warehouse, a current time, and a detected queue length of shoppers waiting to be audited. In one or more embodiments, the risk model (or a separate model) may furthermore determine a scope of the audit including, for example, a number of items to be selected by the auditor for verifying and/or specific items selected based on the model for verifying. Responsive to determining to initiate the audit, the online concierge system 102 invokes 810 an auditing process on the shopper mobile application 212 and the auditor mobile application 214 to facilitate an audit. After receiving 812 verification of the order from the auditor mobile application, the order may be completed 814 and the shopper mobile application 212 may proceed to facilitate delivery of the order to the user 204. For example, the shopper mobile application 212 may generate 816 routing instructions via the shopper mobile application 212 for facilitating delivery by the shopper 208 to the user 204.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one or more embodiments, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising, by one or more processors of a computer system:
receiving, via a customer mobile application, an order from a customer for one or more items from a warehouse;
sending a dispatch command to a shopper mobile application of a shopper, the dispatch command instructing the shopper to travel to the warehouse and acquire the one or more items in the order for the customer;
receiving, from the shopper mobile application, an order status of the order indicating whether the one or more items in the order have been picked or otherwise marked as complete;
detecting that the shopper is ready to exit the warehouse based on the order status received from the shopper mobile application;
applying a trained risk model to the order to determine whether to initiate an audit of the shopper for the order;
determining to initiate the audit based on an output of the risk model;
responsive to determining to initiate the audit, invoking an auditing process on the shopper mobile application and an auditor mobile application of an auditor at the warehouse to facilitate the auditing process;
receiving, via the auditor mobile application, verification of the order from the auditor mobile application; and
responsive to receiving the verification, completing the order and generating routing instructions via the shopper mobile application for facilitating delivery by the shopper to the customer.

2. The method of claim 1, wherein applying the trained risk model comprises:
applying a rule-based risk model to determine whether to initiate the audit.

3. The method of claim 1, wherein applying the trained risk model comprises:
applying a machine learning model to determine whether to initiate the audit, the machine learning model trained on a history of prior audits and respective outcomes.

4. The method of claim 1, wherein applying the trained risk model is based on at least one of: a size of the order, a cost of the order, item types of the one or more items in the order, an experience level of the shopper, a trust metric for the shopper, an audit history of the shopper, a location of the warehouse, configured preferences of the warehouse, a current time, and a detected queue length of shoppers waiting to be audited.

5. The method of claim 1, wherein invoking the auditing process includes:
presenting a scannable code via a user interface of the shopper mobile application for scanning by the auditor via the auditor mobile application;
identifying the order and the one or more items in the order based on the scannable code; and
facilitating auditing of the order by the auditor via a user interface of the auditor mobile application.

6. The method of claim 5, wherein facilitating the auditing of the order comprises:
presenting, via the auditor mobile application, identification of at least a subset of the one or more items in the order; and
presenting, via the auditor mobile application, user interface controls to enable the auditor to confirm presence of the subset of the one or more items or indicate presence of extraneous items outside of the order.

7. The method of claim 6, wherein presenting the user interface controls further comprises:
in response to receiving an indication via the user interface controls of a discrepancy in items presented by the shopper and the order, presenting an interface for obtaining a reason for the discrepancy according to the auditor; and
storing an indication of the discrepancy and the reason in an audit log associated with the order and the shopper.

8. The method of claim 6, wherein presenting the user interface controls further comprises:
determining the subset of the one or more items for verifying by the auditor based on at least one of: respective costs of the one or more items in the order, respective quantities of the one or more items in the order, presence of alcohol in the one or more items in the order, historical data indicative of items most likely to be involved in a discrepancy discovered by the auditing process, and configuration data provided by the warehouse.

9. The method of claim 6, wherein presenting the user interface controls further comprises:
determining the subset of the one or more items for verifying by the auditor based on a machine learning model trained based on historical audit data to identify items most likely to be involved in a discrepancy discovered by the auditing process.

10. The method of claim 6, wherein the presenting the user interface controls comprises:
presenting controls for scanning product codes associated with individual items presented by the shopper; and
matching the product codes to the one or more items in the order to verify presence of the subset of the one or more items or indicate the presence of extraneous items outside the order.

11. The method of claim 6, wherein presenting the identification of at least a subset of the one or more items in the order comprises:
presenting a ranked list of the subset of the one or more items in the order.

12. A computer program product comprising a non-transitory computer-readable storage medium storing instructions that when executed by a processor cause the processor to perform steps including:
receiving, via a customer mobile application, an order from a customer for one or more items from a warehouse;
sending a dispatch command to a shopper mobile application of a shopper, the dispatch command instructing the shopper to travel to the warehouse and acquire the one or more items in the order for the customer;
receiving, from the shopper mobile application, an order status of the order indicating whether the one or more items in the order have been picked or otherwise marked as complete;
detecting that the shopper is ready to exit the warehouse based on the order status received from the shopper mobile application;
applying a trained risk model to the order to determine whether to initiate an audit of the shopper for the order;
determining to initiate the audit based on an output of the risk model;
responsive to determining to initiate the audit, invoking an auditing process on the shopper mobile application and an auditor mobile application of an auditor at the warehouse to facilitate the auditing process;
receiving, via the auditor mobile application, verification of the order from the auditor mobile application; and
responsive to receiving the verification, completing the order and generating routing instructions via the shopper mobile application for facilitating delivery by the shopper to the customer.

13. The computer program product of claim 12, wherein applying the trained risk model comprises:
applying a rule-based risk model to determine whether to initiate the audit.

14. The computer program product of claim 12, wherein applying the trained risk model comprises:
applying a machine learning model to determine whether to initiate the audit, the machine learning model trained on a history of prior audits and respective outcomes.

15. The computer program product of claim 12, wherein applying the trained risk model is based on at least one of: a size of the order, a cost of the order, item types of the one or more items in the order, an experience level of the shopper, a trust metric for the shopper, an audit history of the shopper, a location of the warehouse, configured preferences of the warehouse, a current time, and a detected queue length of shoppers waiting to be audited.

16. The computer program product of claim 12, wherein invoking the auditing process includes:
presenting a scannable code via a user interface of the shopper mobile application for scanning by the auditor via the auditor mobile application;
identifying the order and the one or more items in the order based on the scannable code; and
facilitating auditing of the order by the auditor via a user interface of the auditor mobile application.

17. A computer system comprising:
a processor; and
a non-transitory computer-readable storage medium storing instructions that when executed by the processor cause the processor to perform steps including:
receiving, via a customer mobile application, an order from a customer for one or more items from a warehouse;
sending a dispatch command to a shopper mobile application of a shopper, the dispatch command instructing the shopper to travel to the warehouse and acquire the one or more items in the order for the customer;
receiving, from the shopper mobile application, an order status of the order indicating whether the one or more items in the order have been picked or otherwise marked as complete;
detecting that the shopper is ready to exit the warehouse based on the order status received from the shopper mobile application;
applying a trained risk model to the order to determine whether to initiate an audit of the shopper for the order;
determining to initiate the audit based on an output of the risk model;
responsive to determining to initiate the audit, invoking an auditing process on the shopper mobile application and an auditor mobile application of an auditor at the warehouse to facilitate the auditing process;
receiving, via the auditor mobile application, verification of the order from the auditor mobile application; and
responsive to receiving the verification, completing the order and generating routing instructions via the shopper mobile application for facilitating delivery by the shopper to the customer.

18. The computer system of claim 17, wherein applying the trained risk model comprises:
applying a rule-based risk model to determine whether to initiate the audit.

19. The computer system of claim 17, wherein applying the trained risk model comprises:
applying a machine learning model to determine whether to initiate the audit, the machine learning model trained on a history of prior audits and respective outcomes.

20. The computer system of claim 17, wherein applying the trained risk model is based on at least one of: a size of the order, a cost of the order, item types of the one or more items in the order, an experience level of the shopper, a trust metric for the shopper, an audit history of the shopper, a location of the warehouse, configured preferences of the warehouse, a current time, and a detected queue length of shoppers waiting to be audited.
